(19) United States
(12) Patent Application Publication
(10) Pub. No.: US 2004/0172430 A1
(43) Pub. Date: Sep. 2, 2004

(54) Method and device for acquiring data

(76) Inventor: Hans-Georg Hornung, Waal (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/738,975

(22) Filed: Dec. 19, 2003

(30) Foreign Application Priority Data
Dec. 20, 2002 (DE) 102 60 177.1

(51) Int. Cl. G06F 7/00

(52) U.S. Cl. 708/207

(57) ABSTRACT

In a method and apparatus for acquiring a derived data value from among individual data values generated by a multiplicity of data units which are serially connected in a fixed order, each data unit to which a preceding data unit is assigned receives a data value from the preceding data unit, logically links it to a locally generated individual data value and passes on the resulting data value, so that the data value which is passed on by the last data unit represents the derived data value. The passing on of data values is carried out bit by bit in serial fashion, each data unit linking a received bit to the corresponding bit of its own individual data value, and passing it on before it receives a further bit of the data value.

### BACKGROUND AND SUMMARY OF THE INVENTION

This application claims the priority of German Document No. 102 60 177.1, filed Dec. 20, 2002, the disclosure of which is expressly incorporated by reference herein.

The present invention relates to a method and apparatus for acquiring data, such as a derived data value from individual data values which are generated at multiple data units.

A conventional method for generating such a derived data value is to address successively the data units that are connected via a bus or the like to a control unit (for example a microprocessor), in order to cause them to output their individual data values to the control unit, which then generates the derived data value from the individual data values. Such a method is technically complex, in that each individual data unit must have an interface that is capable of detecting when the respective data unit is addressed by the control unit. The need for such interfaces gives rise to a considerable amount of data traffic on the bus (on which requests to the data units to supply an individual data value, and their responses, are transmitted successively). Particularly high loading results if a packet-oriented bus has to be used, because it is necessary, for example, to connect not only the data units which supply individual data values but also data units which transmit or receive large quantities of data in a short time.

International Patent Document WO 00/68700 discloses a method and apparatus for acquiring a derived data value from data values generated at a multiplicity of data units, in which method and apparatus the data units are not located in parallel on a bus, but instead are connected in series, so that each data unit can receive data values only from a data unit which is located upstream of it, and if appropriate link it to its own data value, and pass on the result to the downstream data unit. In such an arrangement the need to address each data unit individually is eliminated so that the individual data units also do not require an address decoder and therefore can be simplified. The period of time which is necessary to acquire a derived data value is, however, extremely long as the individual data units are connected serially to one another, and each data unit must receive a data value completely from a preceding data unit before linking it with its own individual data value, and finally passing on the result.

It would be possible to reduce these delays by providing parallel transmission of the data values between adjacent data units but such a solution is complex and costly, particularly if the data units are used in an environment in which electromagnetic interference is frequent and therefore the data line has to be shielded.

One object of the present invention, therefore, is to provide a method and apparatus for acquiring a derived data value from individual data values generated by multiple data units, which method and apparatus permit more rapid acquisition, without a significant increase of complexity of circuitry and wiring.

This and other objects and advantages are achieved by the method and apparatus according to the invention, in which each data unit passes on its data value serially in the form of successive “sections” (preferably, individual data bits). Each data unit which receives a section of such a data value links (that is, logically compares) it to the corresponding section of its own individual data value and passes a value on, before it receives a further section of the data value. In this way, linking of the passed-on data value to individual data values of the various data units can take place simultaneously, distributed along a plurality of data units, each data unit processing a different section of the data value at a given time.

The incremental passing on of the data values or their sections from an upstream data unit to a downstream data unit can be implemented easily by means of a data line which is made of a sequence of sections that are separated by signaling equipment units, and whose sections each extend from a transmitter of the upstream data unit to a receiver of a downstream data unit.

For linking of respective data sections (e.g., data bits) as described above, a simple logic operation such as an AND or OR operation can be carried out on the individual sections, without taking into account previously processed sections of the same data value. However, for most practical applications when linking a section of the passed-on data value with a corresponding section of an individual data value it is necessary to take into account the result of the linking of the directly preceding pair of sections of the individual data value and of the passed-on data value.

The order in which the sections are linked depends on the type of linking to be carried out. If, for example, the derived data value is to be a minimum or maximum of the individual data values, the sections are expediently passed on in order of decreasing significance. On the other hand, when the derived data value is defined as the sum of the individual data values or a difference between the individual data values, the sections are passed on in order of increasing significance.

Each data unit which has a preceding data unit and receives a passed-on data value from the preceding data unit, can easily be made to perform a logic operation. The first data unit could have a trigger input for receiving a trigger signal that causes it to pass on an individual data value which it has acquired. However, the first data unit is preferably constructionally identical to all other data units, and is triggered by feeding a neutral data value (that is, a data value whose linking to the individual data value of the first data unit results in this individual data value). If the logic operation which is to be carried out is a summing operation, a neutral data value is zero, and if the logic operation is the formation of a minimum or a maximum, the neutral data value is the smallest or largest number which can be represented in the format which is respectively used to represent the data values.

In the acquisition method and apparatus according to the invention, not only data values, but also instructions (indicating to the individual data units how received data values are to be processed and transferred) are passed on from one data unit to the next. In order to transfer the instructions it is possible, for example, to use a status line which is disconnected from a data line, and whose status indicates at any time how a received data value is to be processed. It is particularly expedient to transmit data values and instructions which define the processing of a data value in succession, preferably in the form of chronologically spaced pulse bursts on a common data line. Alternatively, such pulse bursts may be trained, each comprising an instruction section and a parameter section, the data value on which the instruction transmitted in the instruction section is to be applied is transmitted in each of said parameter sections.

An instruction for acquiring an individual data value is expediently fed simultaneously to all the data units, so that the acquired individual data values each correspond to the same time, even if they are subsequently linked at different times in the data units. For this purpose, each data unit may be equipped with a sample and hold element.

In applications in which the data values to be acquired vary slowly (and therefore small differences in the acquisition times of the individual data units can be tolerated), the instruction for the acquisition of an individual data value can also be passed on successively from one data unit to the other on the data line. This solution has the advantage that a separate line is not required for transmitting the acquisition instruction.

A preferred application of the method or apparatus according to the invention is the acquisition of measurement variables, particularly voltages for a series arrangement of electrical power sources such as cells of a fuel cell stack. In this application, the fact that the data units are not all connected to a common bus (but rather only each connected to one another in pairs), has the additional advantage that the pairwise connections can be positioned in such a way that no large differences in potential occur between the fuel cells assigned to them.

For timing of the transmission of the data values between the data units, the latter are preferably connected by a clocked line, which may be a continuous clocked line to which all the data units are connected in parallel. Preferably, the clocked line comprises (as does the data line) a multiplicity of sections which are separated by the signaling equipment, and which each extend from a transmitter of a first data unit to a receiver of a second data unit. A section of the clocked line preferably runs in each case between two data units which are also connected by a section of the data line, and the clock signal which is transmitted by a transmitter of each data unit has a delay of half a clock period in comparison with the clock signal which is received by the receiver of the same data unit. In this manner, it is possible to reduce the duration of the acquisition of the derived data value once more.

As the operations which are to be carried out at the individual data units are, according to the invention, essentially simple single-bit operations, the data units according to the invention are particularly suitable for implementation in one or more ASICs.

The invention also provides a method for addressing a data unit composed of a multiplicity of data units. For this purpose, an order of the data units is first defined (for example, according to the order in which they have been arranged along the data unit). Each data unit to which a preceding data unit is assigned receives an address value from the preceding data unit and compares it with a value that is predefined in the same way for all the data units. The data unit in question is addressed when there is correspondence with the predefined value. On the other hand, at least when there is noncorrespondence, it changes the addressed value by means of a predefined operation and passes on the address value which is obtained in this way.

In particular if the predefined operation is an incrementation or decrementation, such an address value can be passed on serially in the form of successive sections or bits of increasing significance in a way similar to the passed-on data value mentioned above. Each data unit which receives a section of an address value changes it, or does not do so, depending on whether it is necessary for incrementation or decrementation, and passes it on before such data unit receives a further section of the address value. On the basis of such addressing it is also possible to select, on the individual data values obtained from the data units described above, in each case one individual data value which is generated by the addressed data unit and forward it to a receiver via any data units which follow the addressed data unit.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a block diagram of a fuel cell stack with a device connected thereto for acquiring terminal voltages of the individual fuel cells according to the invention;

FIG. 2 shows a flowchart of a method for acquiring the maximum terminal voltages of the fuel cells;

FIG. 3 shows a flowchart of a method for acquiring the sum of the terminal voltages of the fuel cell;

FIG. 4 shows the time profile of clock signals and data signals in the device from FIG. 1; and

FIG. 5 shows a flowchart of a method for addressing an individual measuring point of the device from FIG. 1 and for acquiring the terminal voltage measured by the measuring point.

### DETAILED DESCRIPTION OF THE DRAWINGS

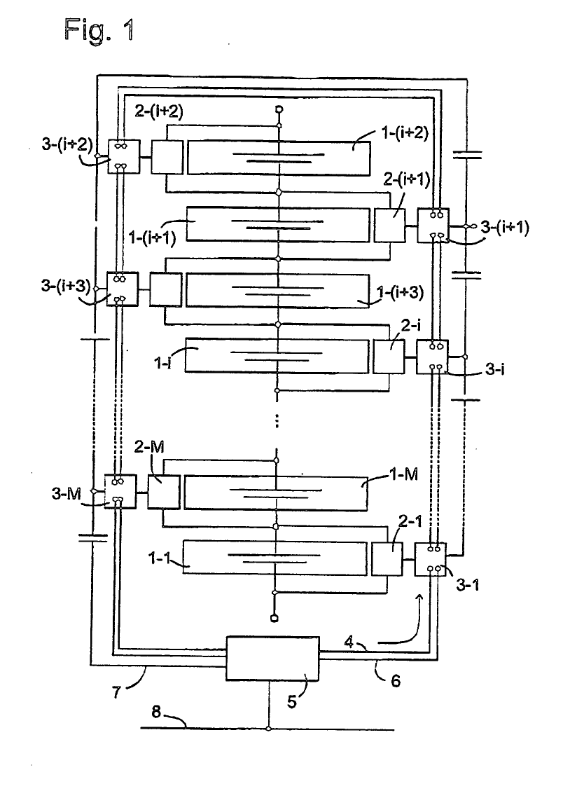

The block diagram in FIG. 1 shows a stack of M fuel cells 1-1 to 1-M which are connected in series, each of which has assigned to it a measuring point composed of an A/D converter 2-i and an interface 3-i, i=1, . . . , M. The A/D converter 2-i is connected in each case to the connecting terminals of the assigned fuel cell 1-i in order to acquire its terminal voltage and to supply to the interface circuit 3-i a digital value which is representative of the acquired voltage. A single-conductor data line 4 runs in a ring shape in series starting from a control unit 5 via the interfaces 3-i and back to the control unit 5. The data line 4 is composed of a multiplicity of sections which are separated from one another in terms of signaling equipment (i.e., a section which connects a transmitter of the control unit 5 to a receiver of the first interface 3-1, a plurality of suctions which each connect a transmitter of an interface 3-i to a receiver of a downstream interface 3-(i+1), and a section which connects the last interface 3-M, to a receiver of the control unit 5). The data line therefore transmits only in one direction (counterclockwise) in FIG. 1, and each interface has control as to whether a signal arriving at its receiver is passed on via its transmitter.

In the embodiment in FIG. 1, most sections of the data line 4 connect interfaces 3 of fuel cells 1 which are “next but one” neighbors in the series connection of the fuel cells. (That is, each interface is connected to the interface of the second nearest fuel cell along the data line, rather to the interface of the immediately neighboring fuel cell.) The interfaces each lie in a floating fashion at the potential of the fuel cell which is assigned to them. In this way, the potential difference which is to be bridged by each section of the data line 4 corresponds in each case to twice the terminal voltage of the fuel cells 1-i. Since the potential difference between interfaces 3-i which are immediately adjacent along the data line 4 is thus low, direct voltage isolation between them is easily achieved, for example by using a capacitor (not illustrated) which is inserted into each section of the data line 4. Of course, it would also be possible for the interfaces of fuel cells which are directly connected to one another electrically in the fuel cell stack to be connected in each case on the data line 4; however, in that case it would be necessary, in one section of the data line 4, to bridge a difference in potential corresponding to the total output voltage of the fuel cell stack, which may require more complex means for direct voltage isolation such as for example an optocoupler.

A clocked line 6 is connected in parallel with the data line 4 in a ring shape from the control unit 5 via the interfaces 3-1 to 3-M and back to the control unit 5. In the same way as the data line 4, it is composed of a multiplicity of sections which are separated by signaling equipment and which each connect a transmitter of the control unit 5 or of an interface 3i to a receiver of a downstream interface 3-(i+1) or of the control unit 5.

The interfaces 3-i are also connected in parallel to a multi-conductor status line 7, which starts from the control unit 5, and on which the interfaces 3 simultaneously receive status or instruction signals from the control unit 5. One conductor of the status line 7 can be used, for example, to transmit a sampling instruction to all the measuring points, which instruction causes them to receive a voltage value of the assigned fuel cell. A sample and hold element for buffering this voltage value until the time of its interrogation by the control unit 5 can be provided in the form of an analog circuit between the connecting terminals of each fuel cell 1-i and of the assigned A/D converter 2-i, or in the form of a digital buffer between the A/D converter 2-i and its interface 3-i.

The status line 7 can be dispensed with if, according to a preferred embodiment, the interfaces 3-i are configured to distinguish instructions transmitted from the control unit 5 via the data line 4 from data, and to evaluate them. This is possible, for example, by transmitting data on the data line 4 in the form of chronologically spaced trains or bursts, the interfaces interpreting a fixed number of bits at the start of each train as an instruction.

The control unit 5 is itself connected to a CAN bus 8 of a motor vehicle via which it receives instructions from a processor (not illustrated), to supply specific data values to the processor, or transmits such data values.

The method of operation of the device shown in FIG. 1 will now be explained with reference to a plurality of examples. First, the case is considered in which the control unit 5 receives an instruction from the processor to supply the value of the maximum of all voltages present at the connecting terminals of the fuel cells 1 at a fixed time. The control unit 5 eventually transmits to all the interfaces 3-1 an instruction to sample and hold the terminal voltage. (Such an instruction can, as indicated above, be transmitted as a signal on a conductor of the status line 7 or as part of a bit train on the data line 4).

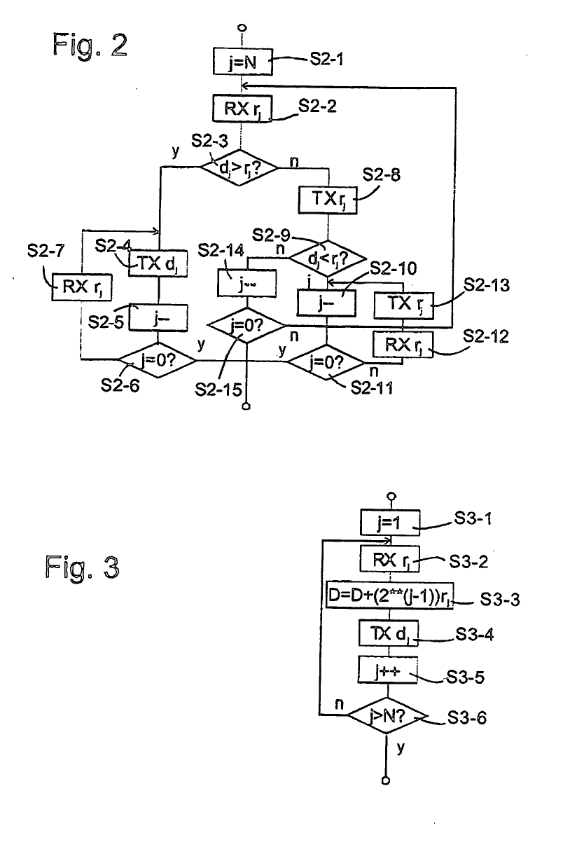

Thereafter, the control unit 5 begins to transmit, bit by bit in synchronism with a clock signal which it simultaneously transmits to the first interface 3-1 via the clock line 6, an N-bit data word whose bits are all zero (N being the resolution of the A/D converters 2). It is not necessary for the control unit 5 to wait until digitization of the obtained data values is finished before it transmits the first of the N bits “zero”. Rather, it is sufficient that, at the start of the transmission, the most significant bit of the sampled data value is present at the interface 3-1, and that the A/D converters 2-i supply the further bits at least the same rate at which the control unit 5 transmits. The processing which the interfaces 3-i carry out when they receive a data value from an upstream interface 3-(i−1), or from the control unit 5 in the case of the interface 3-1, is the same for all the interfaces and is described with reference to FIG. 2.

At the start, an internal register j of the interface 3-i is filled with the value N in step S2-1. The bit rⱼ which is subsequently received on the data line (step S2-2) is compared with the corresponding significant bit dⱼ of the data value D which is acquired by the A/D converter 2-i (S2-3). If dⱼ>rⱼ, this means that, whatever values the bits of R which are still to be transmitted have, the data value D which is acquired by the A/D converter 2-i has to be greater than R. In this case, the method proceeds to step S2-4, transmits the bit dⱼ to the downstream interface 3-(i+1) and decrements the counter j in step S2-5. If the latter has reached the value zero (S2-6), this means that all the N bits have been processed and the method ends. Otherwise, a further bit rⱼ is received (S2-7), and the method returns to step S2-4 where this bit is passed on.

If the result of the comparison in step S2-3 is that dⱼ is not greater than rⱼ, the bit rⱼ is passed on in step 2-8. Thereafter, in step S2-9, it is determined whether dⱼ is smaller than rⱼ (as opposed to being equal to it). If so, it is automatically apparent that, regardless of the values of possibly following, less significant bits of R or D, the data value R has to be greater than D, so that the interface 3-i enters a loop in which, without further comparison of values, whenever j is decremented (S2-10) a further bit rⱼ is received (S2-12) and passed on (S2-13) until j=0 (S2-11).

If the result of the comparison in step S2-9 is that dⱼ is not smaller than rⱼ (that is, the two bits are equal), it is still undecided which of the values R and D is greater. After the decrementing of j (S2-14) and comparison to determine whether j=0, the method therefore returns to step S2-2.

The data value R which is passed on by the interface circuit 3-i in this manner is therefore the greater of the data value R which is received by it and the individual data value D which is obtained from the circuit itself.

If all the interfaces carry out the processing according to FIG. 2, the control unit 5 finally receives, as acquisition result, a value that is equal to the maximum of all the individual data values which have been obtained from the measuring points 2, 3.

It is possible for the minimum of all the data values which have been obtained from the measuring points to be acquired in an analogous fashion if the neutral data value which is transmitted by the control unit 5 to the first interface 3-1 is composed of N bits “1” and the comparisons of the steps S2-3 and S2-9 are interchanged.

In one advantageous embodiment of the method, a counter j is not used; and the initialization step S2-1 and the decrementation operations S2-5, S2-10 and S2-14 are omitted. Instead, the content of a shift register, in which the acquired individual data value D is stored at the start of the method and which outputs the respective most significant stored bit, is shifted by one bit to the left in each of the steps S2-5, S2-10 and S2-14, so that the bits of D are also successively output and compared with the respective corresponding significant bits of R until it is apparent which value is the greater (or smaller) of the two, and the respectively selected value is passed on, as new value R, to the next interface circuit. The period of time between successive bits of the value R which arrive at the interface 3 is used as the stop criterion in steps S2-6, S2-11 and S2-15: if a following bit has to occur for longer than a predefined time period, the interface terminates the method. This method permits, inter alia, a rapid comparison with limited accuracy: the number of bits of R may be smaller than the resolution of the A/D converters 2; in such a case, few significant bits of the data values D remain unevaluated.

With the circuit of FIG. 1, it is also easily possible to acquire the sum of all the terminal voltages of the fuel cells by carrying out the method of FIG. 3. As in the previous case, when the maximum is determined, the control circuit 5 transmits a sequence of “0” bits to the first interface 3-1. Each interface carries out the method shown in FIG. 3. At first, it sets the counter j to 1 (S3-1) so that it subsequently receives (S3-2) the bit rⱼ. In step S3-3, this bit is added, taking into account its significance (that is to say multiplied by a factor 2^{j-1}), to the individual data value D which is acquired by the respective measuring point, in which case a carry-over into its next most significant bit dᵢ₊ᵢ may occur. The bit dᵢ which is obtained in this way is passed on in step S3-4 to the next interface 3 (or to the control unit 5 if the interface in question is the last). After the counter j is incremented (S3-5), it is checked (S3-6) whether the total N bits have been processed. If not, the method returns to step S3-2, if it has, it is terminated.

As is apparent, during the summation according to FIG. 3, the order in which the bits are processed is different from that when the maximum or minimum is determined according to FIG. 2.

Both methods can optionally be carried out in the same device according to FIG. 1 if a conductor is present on the status line 7 or if an instruction is defined which can be transmitted on the data line and which permits the control unit 5 to define the operating mode of the interfaces, according to FIG. 2 or according to FIG. 3.

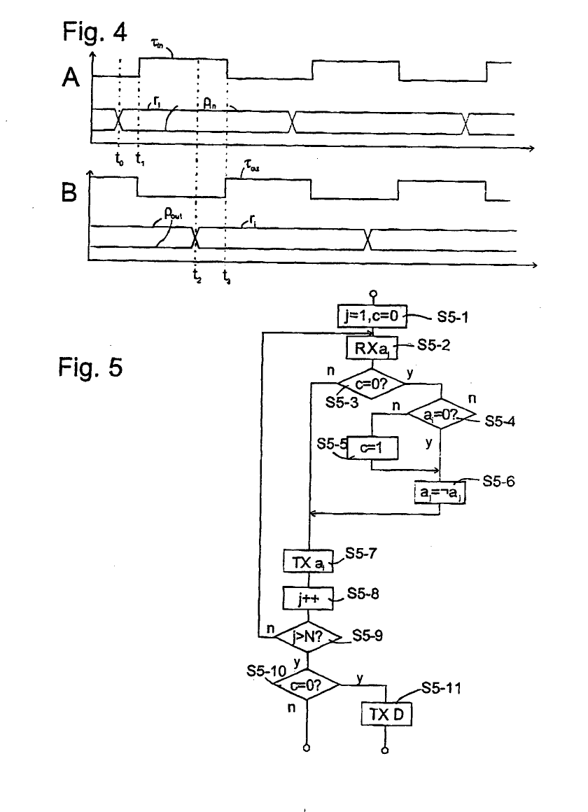

FIG. 4 shows a time profile of the clock signals and data signals at the input (diagram A) or at the output (diagram B) of an interface 3-i. At the time to, in each case at the changeover from one bit of the data value R to be transmitted to the next bit, the data signal, designated by pin in FIG. 4, can change its level. With a short delay, (necessary to stabilize the levels on the data line), the clock signal τin has, at the time τ₁, a rising edge which causes the interface 3-i to accept the value rⱼ present at the input. The interface 3 carries out the linking between the received bit rⱼ and the corresponding bit dⱼ of the individual data value D which is acquired from it, in the manner described above with respect to FIG. 2 or FIG. 3. The result is available at the time t₂ and is output as level rⱼ of the output data signal pout, as shown in diagram B.

The interface 3-i generates a clock signal τₒᵤₜ which is passed on to a downstream interface 3-(i+1) with a phase shift of half a period in comparison with the received clock signal τᵢₙ. If the clock signal τᵢₙ drops away again at the time t₃, and τₒᵤₜ has a rising edge, this causes the downstream interface 3-(i+1) to accept the level rⱼ output by the interface 3-i and to process it. As a result, the number of clock periods which one bit of the data value D requires in order to run through the series connection of the interfaces 3-1 to 3-M is only M/2, while M periods would be necessary with a clock signal which was present synchronously at all the interfaces.

In one embodiment of the summation method which is described with respect to FIG. 3, the step S3-6 is replaced by an operation in which the clock signal τᵢₙ is monitored. If its falling edge does not arrive within an expected time period which the interface 3-i derives from the measurement of the periods of preceding bits, it is concluded that the transmission of R is terminated. If there is a carrier bit from the summation of the directly preceding bits of D and R or if bits of the data value D are still unprocessed, the interface 3-i transmits these bits together with self-generated clock pulses to the downstream interface 3-(i+1) and subsequently stops; otherwise it stops the transmission by stopping the received clock signal. In this method the bit number of R can increase as desired during the pass through the chain of the interfaces. That is, any desired number M of interfaces can be connected in series.

An alternative embodiment of the device from FIG. 1 permits not only maximum values, minimum values and sums of the voltages present at the A/D converters 2-i but also allows the voltage which is present at an individual, selectable A/D converter 2-i to be acquired selectively. For this purpose either an additional address line is necessary (which may be a single-conductor line like a data line 4) for transmitting address information, or an additional conductor of the status line 7 is necessary, the level of which permits each interface 3-i to decide whether the data line 4 is used to transmit a data value or the address information at a given time. If, as described above, not only data but also instructions can be transmitted on the data line, this embodiment can also be implemented without an address line or status line. In the latter case, the address information on the data line is transmitted in each case in conjunction with an instruction which is passed on in unmodified form from one interface to the next and which the address information identifies as such for the interfaces.

A method of operation of the circuit which permits selective reading of individual voltage values is explained with reference to the flowchart in FIG. 5, (in which it is assumed by way of example that the interface to be interrogated is the interface 3-3). Assuming that the number N of bits of the address information is 4, the address information to be transmitted is “0010”. The control unit transmits these address bits in the order of increasing significance, that is to say in the order 0,1,0,0.

The interface 3-1 which is connected directly to the control unit 5 carries out initialization of two internal registers j, c where j=1, c=0. In step S5-2, it receives the first address bit a₁, (which in this example is zero). The step S5-3 is a branch as a function of the value of c. This is at the time 0, with the result that the method changes over to step S5-4. As a₁, is equal to 0, the method changes over directly to S5-6 where a₁, is negated, that is to say set to 1. The value obtained is passed on to the interface 3-2 (S5-7), the counter j is incremented (S5-8) and, as it is still smaller than N (S5-9), the method returns to S5-2. The value a₂=1 is then received. As c is still 0, the method changes over to S5-4 again, but in this case is first set to c=1 in step S5-5 before a₂ is negated in step S5-6. The steps S5-7 to S5-9 are repeated, and a₃=0 is received in step S5-2. As c=1 is now the case, the method changes over directly from S5-3 to S5-7 (that is, a₃ and a₄ are passed on in unmodified form to the interface 3-2). The latter thus receives the bit sequence 1,0,0,0, in accordance with the numerical value 1.

In the step S5-10, the interface 3-1 checks again whether the c=0, and as this is not the case, the method is finished for it.

The interface 3-2 carries out the method in the same way, with the result that the bit sequence 0,0,0,0 is passed on to the interface 3-3. As c=1 is also set at the interface 3-2 when the method is carried out, the method also finishes with step S5-10 here.

In the interface 3-3, the method leads to a situation in which address bits 1,1,1,1 are passed on and c=0 remains the case. Consequently, the method branches here from step S5-10 to step S5-11, and the interface 3-3 is addressed. If the control unit 5 then outputs an instruction for the transmission of an individual data value D to the interfaces, it is the interface 3-3 which responds to it; all the downstream interfaces pass on this individual data value D without manipulating it.

If the interfaces have separate data lines and address lines, the fact that the status line 7 indicates the mode of the selective addressing and that data is transmitted on the data line 4 is sufficient for the downstream interfaces to detect that said data is to be passed on without modification.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. A method for acquiring a derived data value from individual data values generated respectively by a multiplicity of data units which are serially connected in a defined sequence, each data unit to which a preceding data unit is assigned receiving a data value from said preceding data unit, linking it to an individual data value which is generated by said data unit itself, and passing on a data value resulting from such linking, whereby a data value which is passed on by the last data unit in said defined sequence represents the derived data value; wherein:
each respective data unit receives data values serially in the form of successive sections;
each said respective data unit links a received section with a corresponding section of data which is generated by said respective data unit; and
said respective data unit passes on a result of said linking before it links a further received section of ad received data value.

2. The method as claimed in claim 1, wherein each data section consists of a data bit.

3. The method as claimed in claim 1, wherein the linking of the sections is carried out taking into account a result of a pair of sections which were linked directly preceding.

4. The method as claimed in claim 1, wherein:
the derived data value is one of a minimum and a maximum of the individual data values; and
the sections are passed on in order of decreasing significance.

5. The method as claimed in claim 1, wherein:
the derived data value is one of a sum of said individual data values and a difference between said individual data values (D); and
the sections are passed on in order of increasing significance.

6. The method as claimed in claim 1, wherein an acquisition of an individual data value is triggered by inputting a neutral data value into the first data unit.

7. The method as claimed in claim 1, wherein an instruction for the acquisition of an individual data value is fed simultaneously to all data units.

8. The method as claimed in claim 1, wherein an instruction for the acquisition of an individual data value is transmitted successively from one data unit to a following data unit.

9. The method as claimed in claim 1, wherein the data values are measurement variables comprising voltages of a series arrangement of electrical power sources.

10. The method according to claim 9, wherein the electrical power sources are cells of a fuel cell stack.

11. A device for acquiring a derived data value from individual data values generated respectively by a multiplicity of data units which are serially connected via a data line in a defined sequence for the transmission of the data values, each data unit which receives a data value via the data line linking the received data value to an individual data value which it generates itself, and passing on a resulting data value obtained in this manner, via the data line; whereby a data value passed on by the last data unit represents the derived data value; wherein
each respective data unit passes on its data value serially in the form of successive sections; and
each data unit which receives a section of a data value links said section to a corresponding section of its own individual data value, and passes it on before it receives a further section of the data value.

12. The device as claimed in claim 11, wherein the data line is configured in a ring, and runs via a control unit for triggering acquisition of the derived data value and receiving the acquired value.

13. The device as claimed in claim 11, wherein each data unit has a sample and hold element.

14. The device as claimed in claim 11, wherein:
the data line comprises a multiplicity of sections which are separated by signaling equipment; and
each section extends from a transmitter of a first data unit to a receiver of a second data unit.

15. The device as claimed in claim 11, wherein the data units are connected by a clocked line.

16. The device as claimed in claim 15, wherein:
the clocked line comprises a multiplicity of sections which are separated by signaling equipment;
each section extends from a transmitter of a first data unit to a receiver of a second data unit; and
a transmitter of each data unit passes on, with a predefined delay, a clock signal which has been received by a receiver of the data unit.

17. The device as claimed in claim 11, wherein each data unit is implemented in at least one ASIC.

18. A method for addressing a data unit contained in a multiplicity of data units which are serially connected in a defined order; said method comprising:
each data unit to which a preceding data unit is assigned receiving an address value from said preceding data unit;
each data unit comparing the received address value with a predefined value which is identical for all of the data units;
when the received address value corresponds with the predefined value, the data unit is addressed; and
at least when the received address value does not correspond with the predefined value, the data unit changes the address value according to a predefined operation and passes on the resulting address value obtained in this manner.

19. The method as claimed in claim 18, wherein:
the predefined operation is one of an incrementation and a decrementation;
each data unit passes on the address value serially in the form of successive sections of increasing significance; and
each data unit which receives a section of an address value changes it, or not, depending on whether it is necessary for incrementation or decrementation, and passes it on before it receives a further section of the address value.

20. A method for acquiring an individual data value generated by a particular addressed data unit, from among a plurality of individual data values which are generated at a multiplicity of data units which are serially connected in a defined; said method comprising:
each data unit to which a preceding data unit is assigned receiving an address value from said preceding data unit;
each data unit comparing the received address value with a predefined value which is identical for all of the data units;
when the received address value corresponds with the predefined value, the data unit is addressed;
at least when the received address value does not correspond with the predefined value, the data unit changes the address value according to a predefined operation and passes on the resulting address value obtained in this manner; and
the addressed data unit transmitting a data value which is passed on via any data units which follow the addressed data unit.

21. The device as claimed in claim 11,
said data units are also serially connected via an address line;
each data unit compares an address value, received via the address line, with a predefined value which is identical for all of the data units:
when the received address valve corresponds to the predefined value, the data unit outputs a data value onto a data line; and
at least when the received address value does not correspond to the predefined value, the data unit changes the address value according to a predefined operation, and passes on the resulting address value obtained in this manner to a data unit which follows in series.
